(19) United States
(12) Patent Application Publication
(10) Pub. No.: US 2009/0295993 A1
(43) Pub. Date: Dec. 3, 2009

(54) Control systems and methods using markers in image portion of audiovisual content

(75) Inventor: Kumar Gaurav Chhokra, Santa Clara, CA (US)

Correspondence Address: NIXON & VANDERHYE, PC, 901 NORTH GLEBE ROAD, 11TH FLOOR, ARLINGTON, VA, 22203, US

(73) Assignee: TOSHIBA AMERICA CONSUMER PRODUCTS, LLC, WAYNE, NJ (US)

(21) Appl. No.: 12/318,758

(22) Filed: Jan. 7, 2009

Related U.S. Application Data
(60) Provisional application No. 61/006,339, filed on Jan. 7, 2008.

(51) Int. Cl. H04N 5/44; G11B 27/00; G06K 9/46

(52) U.S. Cl. 348/553; 386/52; 382/190; 348/E05.096; 386/E05.001

(57) ABSTRACT

An example filtering system for filtering audiovisual content includes a detector arranged to detect presence of a specified marker in an image portion of the audiovisual content and a control system, responsive to the detector, for filtering the audiovisual content.

### CROSS-REFERENCE TO RELATED APPLICATION

This application claims the benefit of U.S. provisional application No. 61/006,339, filed Jan. 7, 2008, the contents of which are incorporated herein in their entirety.

### BACKGROUND AND SUMMARY

This application generally describes a system and method for detecting features or “markers” in audiovisual content and controlling certain functions and/or operations of a device such as a television, set-top box, and the like based on the detecting.

By way of example without limitation, channel icons are often present (generally in the lower right corner) during television programs. These channel icons are generally not present during commercial breaks in the program and thus these channel icons can be used in the systems and methods described herein as “markers” that mark when a program (as opposed to commercials) is being shown. Thus, the presence/absence of such markers can be used to distinguish between program content and advertising content.

By way of illustration and without limitation, a filtering system and method for filtering audiovisual content are described herein. An example filtering system includes a detector arranged to detect presence of a specified marker in an image portion of the audiovisual content and a control system, responsive to the detector, for filtering the audiovisual content. As mentioned above, the specified marker can be a channel icon although other markers can also be used. For example, program rating icons relating to the content rating of television programs are often shown (generally in the upper left corner) at the beginning of a program and after commercial breaks. Thus, these program rating icons can be used as a marker for the beginning of program content.

The filtering of the content may for example involve controlling a recording device to record only the program content. This can be done in near real-time by using the detection of the channel icons to control the recording of a broadcast program to a storage device such as a hard disk drive. Alternatively, the filtering can be done on content that is already recorded, i.e., already stored in a storage device.

Other implementations are also possible. For example, in televisions including multiple tuners, a viewer can tune to a different channel(s) during commercial breaks in a program that the viewer is watching. When the channel icon marker is detected in the image for the channel on which the watched program is being shown, the viewer can be provided with a prompt that the watched program has resumed or the television can be forced-tuned back to the channel airing the program. In still another implementation, the absence of the channel icon from the image can be used to automatically initiate a picture-in-picture (PIP) mode in which the viewer can tune to different channels in the main viewing window while commercials are shown in the PIP window during the commercial break. The PIP mode can be automatically ended when the channel icon is again detected to be present in the image for the channel on which the program is being shown.

These and other features and advantages will be better understood from a reading of the following detailed description in conjunction with the accompanying drawings.

### BRIEF DESCRIPTION OF THE DRAWINGS

FIG. 1 shows a content filtering system 100 in accordance with a non-limiting example implementation of the systems and methods described herein.

FIG. 2A shows portions of illustrative contents of example channel icons database 112 and FIG. 2B shows portions of illustrative contents of example program rating icons database 114.

FIG. 3 shows an example screen display in accordance with an illustrative training process.

FIG. 4 shows an example program time-line.

FIG. 5 shows a non-limiting, example timeline representation of a recorded program along with indicia of when the system determined that commercials are present.

### DETAILED DESCRIPTION OF NON-LIMITING EXAMPLE EMBODIMENTS

When recording broadcast content, advertisements take a significant amount of storage space. For example, half-hour programs often include up to eight minutes of commercials. Thus, if a viewer records his/her favorite half-hour sitcom, 25% or more of the storage space for the program will contain commercials. This wastes recording space because viewers generally do not care to watch the commercials and often fast-forward through the commercials when playing back the recorded program. This waste is exacerbated, for example, if large amounts of broadcast content are being archived, e.g., by a public library or other organization to serve as a historical record of broadcast transmissions.

Existing techniques for attempting to distinguish between program content and advertising content are typically based on signals embedded in the VBI (vertical blanking interval) and these signals are examined to differentiate between program content and advertisements. For example, one technique looks for ratings data on line 21 of the VBI and another examines closed-captioning data on line 21. Still other techniques use analog methods of examining analog audio and video signals to detect periods of “silence” to determine if there is a pause in content transmission.

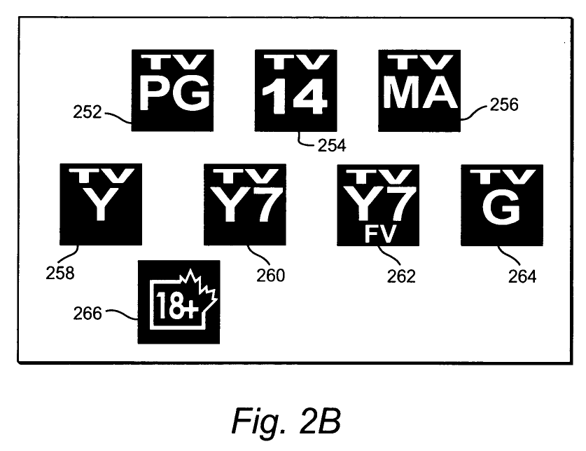

A station typically displays a channel icon (which, for example, contains its logo, call letters, etc.) when program content is shown and thus this channel icon may be used as a marker for distinguishing between program content and commercials. As shown in FIG. 3, a channel icon 306 is generally shown in the lower right corner of a visible picture 308 shown on a television screen 310. Essentially, the continued absence of a channel icon may be interpreted as the end of program content. In one example implementation described below, an image processing program or routine can periodically detect the presence of a channel icon to determine if program content is being shown. If the channel is found to be missing for a sustained period of time (e.g., five to ten seconds—although the exact duration maybe determined experimentally or be set by the user as a parameter for a given channel), recording of the program can be stopped, for example.

In addition, most broadcast stations display the rating for a given program in the visible picture. With reference to FIG. 3, the program rating 304 is usually shown in the upper left corner of the picture 308. Generally, the rating is displayed a few seconds into the start of the actual content and typically precedes any relevant “action”. Hence, the displayed rating can serve as a marker for the beginning of program content.

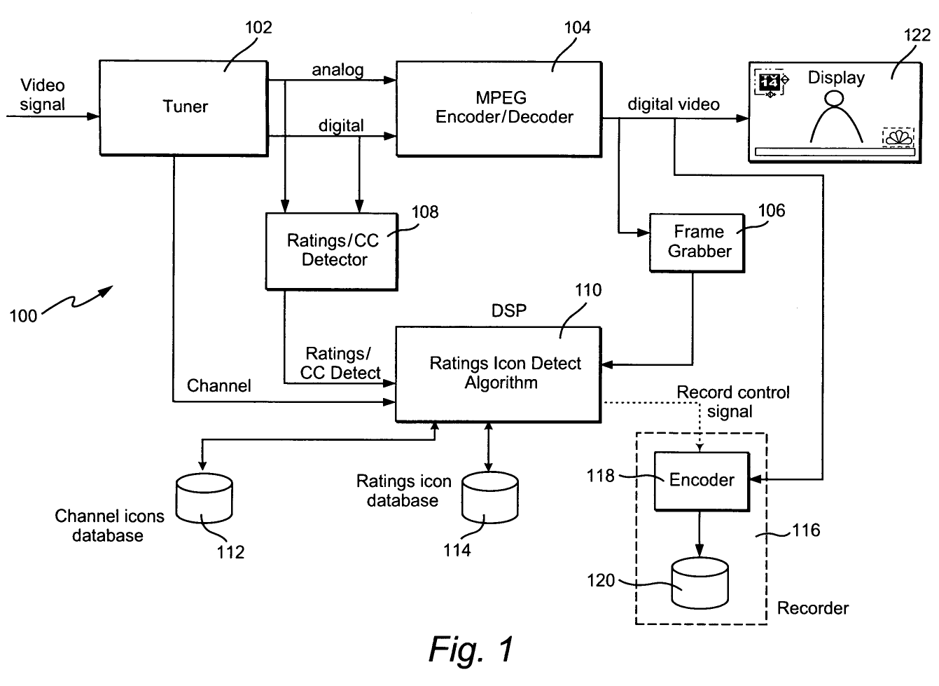

FIG. 1 shows a content filtering system 100 in accordance with one non-limiting example implementation of the systems and methods described herein. The example system is completely transparent to the final signal display. That is, the final picture display is independent (will work the same whether the icon detection is on or off) and unaffected by the icon detection system. Example system 100 includes a tuner 102, an MPEG encoder/decoder 104, a frame grabber 106, a ratings/closed captioning detector 108, a digital signal processor (DSP) 110, a channels icon database 112, a ratings icon database 114 and a recorder 116. Recorder 116 includes an encoder 118 for encoding the audiovisual content for storage in a memory 120. Recorder 116 is controlled in accordance with a record control signal supplied by DSP 110.

Tuner 102 is supplied with a broadcast signal, e.g., from a cable network, a satellite network, or an antenna for over-the-air channels. These signal sources may include analog feeds or channels, digital feeds, or both. A switch (not shown) may be provided for switching between or among two or more of such signal sources. Input from other sources such as a VCR, DVD player and the like (not shown) may be directly supplied to MPEG encoder/decoder 104. Analog and digital outputs from tuner 102 are supplied to MPEG encoder/decoder 104. Example system 100 is designed to work with both analog and digital signal feeds. For analog signals, a frame is digitized and converted to a digital image by MPEG encoder/decoder 104. Alternatively, the entire analog signal can be re-encoded to a digital signal and processed as a digital feed. Frame grabber 106 is used to extract individual frames as static images from the video feed for the currently tuned channel output from MPEG encoder/decoder 104. The digital still images are then fed to DSP 110 running an icon detection algorithm. Although FIG. 1 shows a digital signal processor for running the icon detection algorithm, other types of processing components such as microprocessors, controllers, microcontrollers, application specific integrated circuits (ASICs), programmed logic and the like may be used alone or in combination. The detection algorithm can be a simple scan-line algorithm in which each line of the digital image is scanned for the presence of a block of specified color. In this example, “block” refers to a region of pixels of the same color. For example, consider the TV ratings icons. These are generally squares of solid black filled with white text. The top and bottom regions (and the sides too) include multiple adjacent rows (columns) of pixels of the same (or similar) color. A simple algorithm would assume that if 5 (for example) rows of the same color (black in this case) happen in the region where the ratings icon should be, then a ratings icon is being displayed. These adjacent rows would represent the “block”.

Alternatively, a more complicated deformable template-based correlation may be used in which a set of known shapes are deformed to match a portion of the extracted frame to determine the best match. 2D image correlation is a well known method of detecting presence of a given image in another when basic image characteristics (size, rotation, colors) are constant. By way of example and without limitation, such correlation may be performed using tools available in MATLAB (a scientific computation tool from Mathworks Inc. that performs matrix manipulations) or in image processing tools available from Lead Technologies. The following paper describes a deformable template based detection method: Sclaroff & Liu, “Deformable shape detection and description via model-based region grouping”, IEEE transactions on Pattern Analysis and Machine Intelligence, 23(5), 475-489. The contents of this paper are incorporated herein by reference.

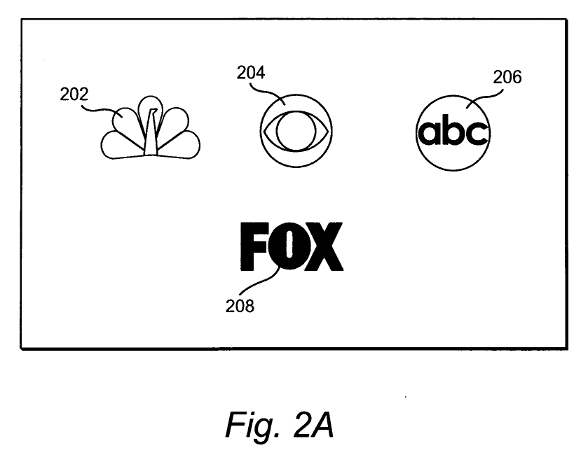

Channel icons database 112 includes a library of known channel icons (see icons 202, 204, 206 and 208 in FIG. 2A) and program rating icons database 114 includes a library of known program rating icons (see icons 252, 254, 256, 258, 260, 262, 264 and 266 in FIG. 2B). Databases 112 and 114 can be accessed by DSP 110 running the icon detection algorithm to perform matching. Databases 112 and 114 can be augmented by the user during training as described in greater detail below.

A ratings/closed captioning detector 108 detects the current rating of a program and the corresponding closed-captioning data from data embedded in the feeds (e.g., line 21 of the VBI for analog channels, PSIP data for digital channels or metadata). This information (along with the channel currently tuned by tuner 102) can be used by DSP 110 as “hints” for determining which icons to search for. Recorder subsystem 116 is controlled by an output of the DSP 110 so that only relevant programming signals are recorded. For example, the icon detection algorithm running on DSP 110 periodically (e.g., every second) examines frames for the currently tuned channel to attempt to detect the presence of channel icons. If the presence of a channel icon is detected, a signal to initiate recording is supplied by DSP 110 to recorder 116. When the icon detection algorithm does not detect the presence of a channel icon for a certain period of time (e.g., five to ten seconds), a signal to stop recording is supplied by DSP 110 to recorder 116.

The efficacy of any icon searching algorithm is greatly increased if the location and the type of image being searched for can be determined beforehand. Channel icons are widely known and are generally uniformly positioned (in the lower right corner) from program to program on a given channel, making the image search for channel icons a relatively quick process. The program ratings icons may vary across channels, but are generally uniform for a given channel and program as are their locations (usually top left corner). Again, this enables a relatively efficient detection of the presence of such icons.

The example system may include a training process to locate channel icons and/or program rating icons for channels that vary the characteristics (e.g., pattern) and/or locations from the defacto standards for the channel icons and program rating icons. The training process is initiated, for example, by making a menu selection from a user interface or pressing a particular key, or combination of keys, on a remote control. With reference to FIG. 3, initiating the training process using remote control 318 causes a viewer-positionable “search window” 302 or training-box to be displayed on screen 310. Window 302 may be positioned using any available user interface devices (e.g., the left, right, up and down arrows on remote control 318) to define the area where the channel and/or rating icons are expected to appear. For example, while watching a program on a particular channel, the viewer can initiate the training mode and position the search window so that the channel icon is contained therein. In some implementations, the training process can allow the user to resize the horizontal and vertical dimensions of the search window to even more particularly conform the size of the window to the size of the channel icon. By pressing a select or enter button on remote control 318, the system can update the contents of the channel icon database 112 for a particular channel to include the position and/or size of the search window and a captured image of the channel icon. This information can be used by the icon detection algorithm during the detection process. For example, when a viewer tunes to a channel for which such information is stored in database 112, the algorithm can use the stored window position information to determine where to search for the icon in the picture and use the captured image of the icon for comparison with the extracted portion of the image.

Alternatively or additionally, information in databases 112 and 114 may be supplied in whole or in part by a factory-installed icons or icons acquired “in-the-field” via downloads from the Internet or from memory cards connected to a memory card reader. Information from downloaded interactive program guide data may also be used.

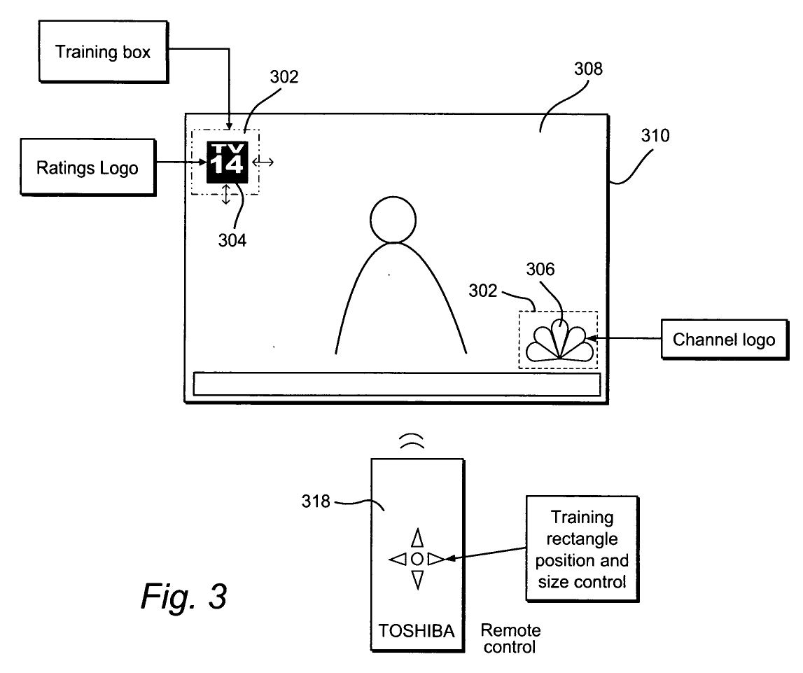

Content filtering may be done in real-time, near real-time, or as a post-processing operation on a complete recorded digital stream. When only program ratings icons are used and no channel icons are available, post-processing or near-real-time editing (e.g., on digital video recorders) can be used to heuristically edit the programming. For example, consider the timeline shown in FIG. 4. The “|” marks in FIG. 4 represent when the ratings icon appear; “!!” represents when the unwanted content starts and ends; “−” represents wanted content; and “=” represents unwanted content. Note that in FIG. 4, the ratings icon appears after some wanted content has already started. With a recorded stream such as that shown in FIG. 4, the system identifies the appearance of a ratings icon at time T3. It then steps back a specified time (e.g., experimentally determined or set by a user) to estimate the start of actual content (time T2). This specified time is generally on the order of a few (e.g., one to five) seconds. From time T2, the system backs a specified time (e.g., experimentally determined or user defined) to estimate the start of the unwanted content, T1. For example, advertisement breaks are typically 90-120 seconds. The content during the time period from T1 to T2 can then be discarded.

Some content providers use “late breaks” in which the commercial frequency and duration increases towards the end of the show. The system can, for example, use a schedule of varying durations to compensate for this.

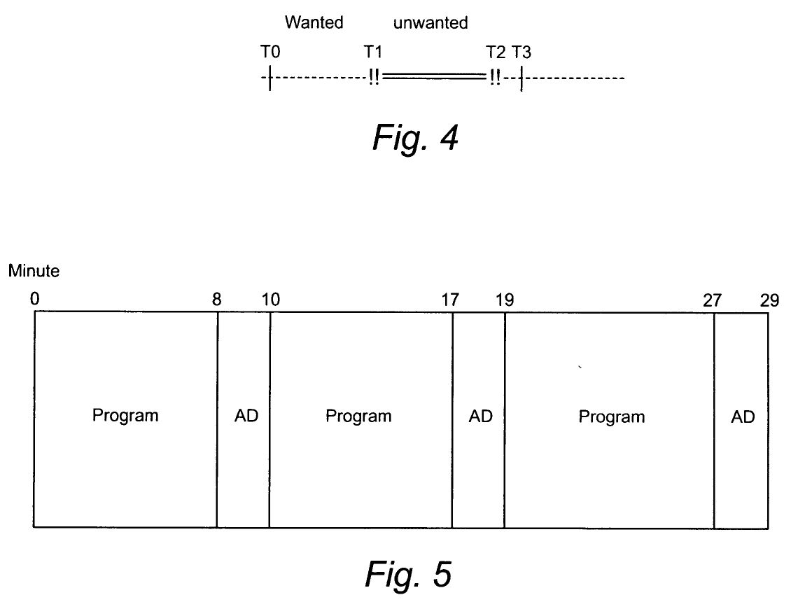

In another example implementation described with reference to FIG. 5, the viewer can be provided an opportunity to confirm that the system has correctly identified the commercials in a recorded program before the system deletes these commercials from the recording. FIG. 5 shows a non-limiting example timeline representation of a recorded program along with indicia (i.e., “PROGRAM” and “AD”) of the content that the system determined to be program content and the content that the system determined to be commercial (advertising) content. The viewer can, for example, select to view or playback the portion(s) audiovisual content determined by the system to be commercials to confirm that this is the case. The viewer can then confirm that these commercials can be deleted and the system can store the thus edited audiovisual content.

The start/end detection of program content can also be combined with detection of other markers to improve accuracy. The markers include, but are not limited to, ratings and closed-captioning data in the VBI and abrupt changes of visual and audio scenes (since typically desired content has scenes that are related to each other). When used in conjunction with the ratings data in the blanking signal, this system may also be used as a “parental monitor” or filter to block programming considered inappropriate for certain viewing audiences.

Other implementations are also possible. For example, in televisions including multiple tuners, a viewer can tune to a different channel(s) during commercial breaks in a program that the viewer is watching. When the channel icon marker is detected in the image for the channel on which the watched program is being shown, the viewer can be provided with a prompt that the watched program has resumed or the television can be forced-tuned back to the channel airing the program. In still another implementation, the absence of the channel icon from the image can be used to automatically initiate a picture-in-picture (PIP) mode in which the viewer can tune to different channels in the main viewing window while commercials are shown in the PIP window during the commercial break. The PIP mode can be automatically ended when the channel icon is again detected to be present in the image for the channel on which the program is being shown.

The system may also be used to preferentially compress advertisements more than program content to allow more program content to be recorded while still maintaining the advertisements. Existing MPEG compression techniques use variable bit rate (VBR) compression, but these techniques are not based on the type of program content. Specifically, existing VBR techniques allocate bit-rate budgets solely on the “busy-ness” of the video being recorded. For example, fast paced video (e.g., sports) or sequences with lots of fine details (e.g., large crowds at a distance) require higher bit-rates/bandwidths/storage space as compared to scenes with static scenery (e.g. a couple of stationary actors) or slow changing gradients (e.g. distant sunsets). Current VBR techniques would devote more resources to an advertisement of a sporting event (e.g., a montage of basketball players dunking) vs. a movie scene where a cowboy rides into the sunset. The systems and methods described herein could recognize an advertisement and preferentially compress it more than a movie. One would thus retain continuity (and quality of the movie) and yet save space.

The system may also be used as an auto-index generating mechanism in which a DVD-like chapter-menu (e.g., chapter numbers) for the recorded material is auto-generated. If closed captions are found, some of the close-captions may be attached as titles for the scenes.

The systems and methods described herein may be implemented in hardware, firmware, software and combinations thereof. Software or firmware may be executed by a general-purpose or specific-purpose computing device including a processing system such as a microprocessor and a microcontroller. The software may, for example, be stored on a storage medium (optical, magnetic, semiconductor or combinations thereof) and loaded into a RAM for execution by the processing system. The software may also be executed from a ROM. Further, a carrier wave may be modulated by a signal representing the corresponding software and an obtained modulated wave may be transmitted, so that an apparatus that receives the modulated wave may demodulate the modulated wave to restore the corresponding program. The systems and methods described herein may also be implemented in part or whole by hardware such as application specific integrated circuits (ASICs), field programmable gate arrays (FPGAs), logic circuits and the like.

While the systems and methods have been described in connection with what is presently considered to practical and preferred embodiments, it is to be understood that these systems and methods are not limited to the disclosed embodiments.

I claim:

1. A filtering system for filtering audiovisual content, comprising:
a detector arranged to detect presence of a specified marker in an image portion of the audiovisual content; and
a control system, responsive to the detector, for filtering the audiovisual content.

2. The system according to claim 1, wherein the audiovisual content comprises broadcast audiovisual content.

3. The system according to claim 1, wherein the audiovisual content comprises recorded audiovisual content.

4. The system according to claim 1, wherein the specified marker comprises an icon.

5. The system according to claim 1, wherein the specified marker comprises program ratings icon.

6. The system according to claim 1, wherein the specified marker comprises a channel icon.

7. The system according to claim 1, wherein the filtering comprises selectively inhibiting output of the audiovisual content.

8. The system according to claim 1, wherein the filtering comprises selectively inhibiting output of the audiovisual content to a recording device.

9. The system according to claim 1, wherein the filtering comprises selectively inhibiting storage of the audiovisual content in a memory.

10. The system according to claim 1, wherein the detector compares an extracted part of the image portion with a library of stored markers, and, based on the comparing, detects the presence or absence of the specified marker.

11. The system according to claim 1, wherein the detecting of the presence of a specified marker in an image portion of the audiovisual content is at least partly based on data included in a non-image portion of the audiovisual content.

12. The system according to claim 11, wherein the non-image portion comprises a blanking interval.

13. The system according to claim 11, wherein the non-image portion comprises a closed-captioning stream.

14. The system according to claim 11, wherein the non-image portion comprises program and system information protocol (PSIP) data.

15. The system according to claim 11, wherein the non-image portion comprises metadata.

16. A method for filtering audiovisual content, comprising:
detecting a specified marker in an image portion of the audiovisual content; and
filtering the audiovisual content based on the detecting.

17. A method comprising:
detecting a specified marker in an image portion of the audiovisual content; and
variably compressing the audiovisual content for recording based on the detecting.

18. A method comprising:
detecting a specified marker in an image portion of the audiovisual content; and
selectively recording the audio-visual content based on the detecting.

19. The method according to claim 18, further comprising:
automatically generating menu information for the recorded audio-visual content.

20. The method according to claim 19, wherein the automatically generated menu information is generated, at least in part, based on closed-captioning information.

21. A training system comprising:
an interface configured so that a user designate a position of an image portion of a picture on a television screen;
storage for storing the designated position; and
a processing system for using the designated position stored in the storage to detect the presence of the image portion in subsequent pictures displayed on the television screen.
